(19) United States
(12) Patent Application Publication
(10) Pub. No.: US 2006/0218826 A1
(43) Pub. Date: Oct. 5, 2006

(54) Tapeler1

(76) Inventor: Carl Cetera, Tenafly, NJ (US)

Correspondence Address: THE SONI LAW FIRM, 55 S. LAKE AVE SUITE 720, PASADENA, CA, 91101, US

(21) Appl. No.: 11/096,961

(22) Filed: Mar. 31, 2005

(51) Int. Cl. B43M 17/00

(52) U.S. Cl. 40/358

(57) ABSTRACT

A multi-function fastening device which includes a stapling function as well as a tape dispenser, further having an ergonomic design with contoured cushioned hand gripping portions and graphical or advertising imprinted material on its outer surface(s). The Tapeler may further include a clip for quick attachment to a belt or to another article.

### FIELD OF THE INVENTION

The present is directed to a hand held implement which may also be carried as an attachment to one's belt, harness or work area. The invention is ideally directed to commercial uses in an office or warehouse environment, as it includes multiple fastening means typically utilized in those environs. As described and claimed below, this invention is directed to an ergonomically designed fastening device to facilitate comfortable and easy multi-purpose uses and which may be clipped to another article. The invention is directed to the use of staples, small brad nails or similar fasteners, however, the invention also includes an integral tape dispenser.

### BACKGROUND OF THE INVENTION

In the past, traditional fastening implements were generally directed to performance of a single task, such as a stapler or a tape dispenser. In addition, these implements generally were either small light duty desk implements or large and bulky industrial devices. Moreover, these fastening devices typically had no means by which they may be easily carried by the user and maintained at the ready in any environment to perform a multitude of fastening tasks, for example in a warehouse operation. Lastly, the repetitive use of a hand held implement such as a stapler often led to fatigue of the user's hand, and, in extreme cases, to medical and neurological issues such as carpal tunnel syndrome.

Prior attempts have been made to design multi-functional fastening devices to incorporate the stapling and tape dispensing function. For example, U.S. Pat. No. 4,727,610, to Lin discloses and claims a stapler with integral tape dispenser. That device, however, does not satisfy the need for a multifunction device in a commercial or industrial environment. The device it is a light duty design with no means by which it may be attached to a belt or another article and it is essentially a formed device with rectangular leg portions, ill suited to the repetitive and frequent use as such use would quickly lead to hand and nerve fatigue and associated problems.

Others have utilized a curved shape in a stapling device, such as U.S. Pat. No. 6,152,347, to Wilson, et al. Once again, however, these devices have no incorporated stapling and tape dispensing function, nor do they contemplate a conveyance and attachment mechanism to provide quick and efficient use in any situation.

In conjunction with the less than efficient use, the previously designed devices are typically designed to rest either upright or on only one outer surface, and will not be balanced and stable when rested in any number of positions, such as on one of their leg portions or on an end. This leads to dropping the device, having it fall off the work surface and generally having to fumble with the device rather than being able to quickly rest the device on a surface and grab it when necessary without concern to its resting orientation.

Finally, with the tremendous utility of a device as contemplated in the present invention, it is essential that it have surface imprinting areas for advertising or graphics. The contemplated invention would be most desirable and would be a valuable promotional item for those businesses which provide services or products to commercial or industrial operations.

What is needed is a versatile and attachable multi-function fastening device which is designed with the industrial or commercial user in mind. Such a device must be efficient and easy to comfortably use for multiple fastening tasks and must be designed to be always within reach of the user.

### SUMMARY OF THE INVENTION

The present invention is directed to provide the user in a commercial or industrial setting with a multi-function fastening device. Another object of the invention is to provide the fastening device which will be readily available at all times and provide ergonomic comfort for continuous and frequent use. A furher object of the invention is to provide a device which is highly desirable and will become a valuable promotional item, and accordingly, must have smooth and flat surfaces on which a business or professional's advertizing or desired graphics may be imprinted.

The present invention accomplishes these and other objectives by providing a multi-functional fastening implement which has ergonomically contoured and cushioned grips, numerous positions in which it may rest on a surface and many flat smooth surfaces on which material may be imprinted. The Tapeler, as it will be known, is envisioned to have many differing embodiments, based on the needs of the intended user. It will primarily dispense a fastening means of staples or small brad nails, with concurrent capability to dispense any type of tape product which is available in roll form. These products could include adhesive tape, carpet tape, fiber tape or any other similar functioning roll product.

The Tapeler, however, is far more than a simple fastening device. It is designed and configured to be easily grasped, and to be carried by the user so as to be constantly ready to use. To accomplish these objectives, the Tapeler first incorporates ergonomic contoured and cushioned grip leg portions. The use of these contoured cushioned surfaces facilitates tireless use of the device with less likelihood of developing hand fatigue and neurological symptoms commonly associated with continuous repetitive had tasks. Additionally, the Tapeler is designed so it may be placed on its end, its legs or flat on its sides upon any work surface. As such, the user need not be concerned about carefully placing the device on the work surface between uses. The multitude of resting surfaces inhibits its falling, rolling or otherwise becoming displaced from the work surface. This ease of use leads to more efficient use of the device and less fumbling and blind reaching for the device during use.

Moreover, the Tapeler may incorporate an integral mounting for a belt clip or other common attaching device. As such, the Tapeler is truly designed for an industrial or commercial setting, as it may be easily transported yet remain constantly at the ready for any fastening task which one may encounter.

### BRIEF DESCRIPTION OF THE DRAWINGS

These and other aspects of the invention will now be described with reference to the accompanying drawings, in which:

FIG. 1 is a perspective view of a preferred embodiment of the Tapeler assembly, which depicts the contoured ergonomic grip of the stapling leg as well as the stapling and tape dispensing portions of the invention.

FIG. 2 is a side view of a preferred embodiment of the Tapeler assembly, which depicts the tape dispensing and stapling functions at opposite ends of the device, the two ergonomic gripping legs and a raised circular surface upon which graphical or advertising materials may be imprinted.

FIG. 3 is a top view of a preferred embodiment of the Tapeler assembly, which again depicts the tape dispenser and the ergonomic grip of one leg of the invention.

FIG. 4 is an end view of a preferred embodiment of the Tapeler assembly, which depicts the contours of both of the legs as well as the stapling head portion of the invention.

FIG. 5 is a view of the opposite end of a preferred embodiment of the Tapeler assembly, which depicts the tape dispensing mechanism.

FIG. 6 is a bottom view of a preferred embodiment of the Tapeler assembly, which depicts the contoured grip of the staple forming leg, as it incorporates both a contoured portion for gripping and a flat portion which provides a stable and non-slip surface upon which the Tapeler may rest.

### DETAILED DESCRIPTION OF THE INVENTION

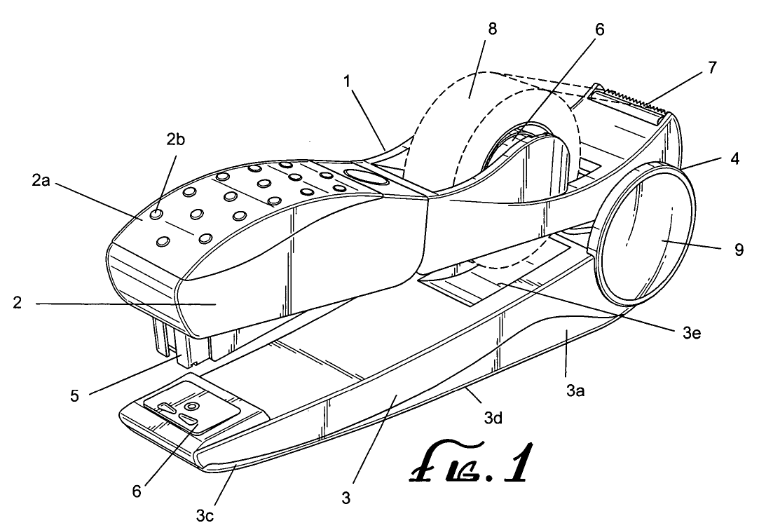

The Tapeler comprises a multi-functional device which incorporates a staple fastening portion and a tape dispensing portion within an ergonomic assembly for ease of use. As shown in FIG. 1, the Tapeler 1, is comprised of a stapling leg 2, which is attached to a staple forming leg 3, through a pivoting connection 4. Referring to FIGS. 1 and 4, a preferred embodiment of the Tapeler a conventional stapling head 5, is mounted within the stapling leg 2. On this stapling leg 2, a cushioned grip 2a, provides a comfortable and efficient contoured gripping surface, which optionally may further include non-slip surface projections 2b, or indentations.

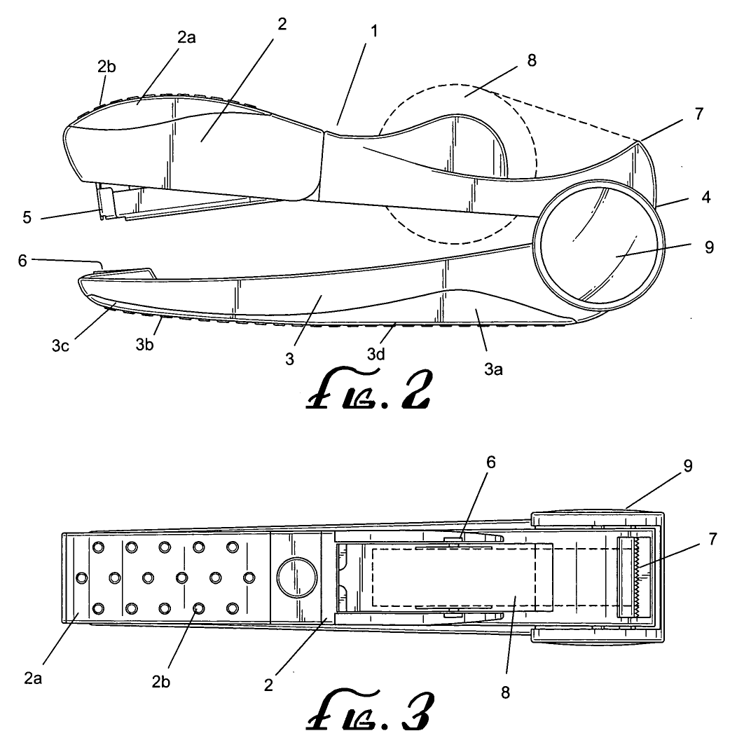

As shown in FIGS. 1, 2 and 3, the stapling head 5, in the preferred embodiment mates with a forming plate 6, which is mounted atop the staple forming leg 3. This forming leg 3 also includes a similar cushioned grip surface 3a, which is curved and contoured toward the gripping end 3c, and proceeds to a flat portion 3d, that extends along the bottom length of the Tapeler 1. On the inwardly facing surface of the forming leg 3, a relieved section 3e, permits the user to utilize the stapling function of the Tapeler while a fully sized tape roll 8, remains loaded on the invention. Referring to FIGS. 2 and 6, the flat portion 3d, is utilized to provide a non-slip surface on which the device may be rested on a surface. The forming leg surface 3a may similarly include non-slip projections 3b.

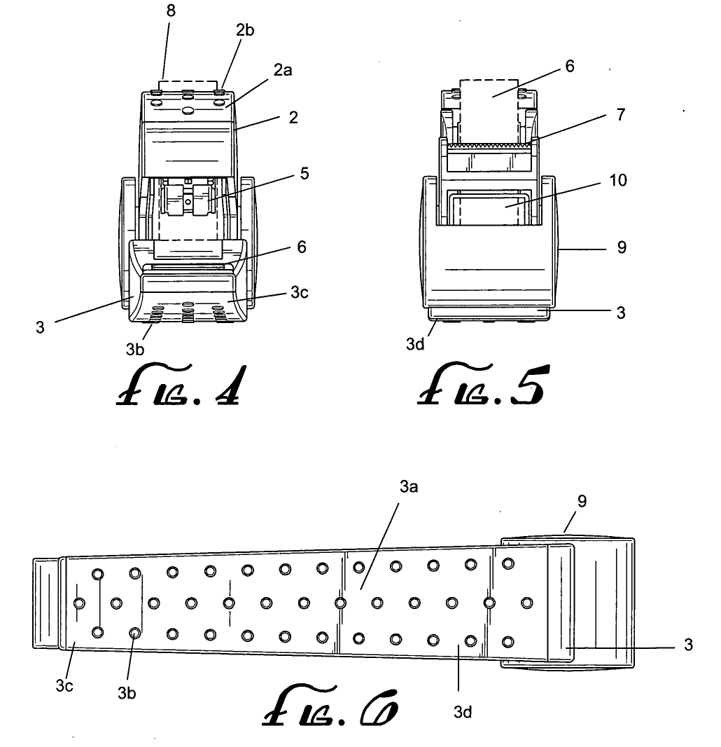

Referring to FIGS. 2 and 5, the tape dispensing spool 6, is oriented in the preferred embodiment to be opposite the stapling head 5 of the Tapeler. The spool 6 is aligned with a cutting edge 7, so the tape 8 may be cut to size upon dispensing. These figures also depict a raised circular boss 9, at the pivot connection 4 location, between the stapling leg 2, and the staple forming leg 3. This boss 9 is included in the preferred embodiment to provide a prominent surface on which graphical or advertising materials may be imprinted. The use of this area for imprinting diminishes the prospects that the imprinting will fade or become worn off from repeated hand gripping, as would be the case of imprinting on a surface of one or both of the leg portions.

FIG. 5 further depicts the clip opening 10, into which a belt clip or other attachment means would be inserted for ready attachment to another article.

Although the depicted preferred embodiment describes a device for use with staples and adhesive tape, the contemplated invention is not so limited. Embodiments are within the scope of this invention that use small brad nails, pins, tacks or any other fastening means which may be loaded into a stapling type device. Associated with these embodiments, the pivot connection 4, of the invention which maintains the preferred embodiment in a typical “stapling” position may be released in a conventional manner, so as to permit the stapling leg and staple forming leg to be aligned 180° with respect to one another, to permit driving fasteners into a surface without need of the forming plate.

Similarly, while the preferred embodiment depicts the Tapeler loaded with what appears to be ordinary adhesive tape 8, it may be utilized with any roll formed product, including but not limited to as carpet tape, double sided tape, drywall tape, fiberglass joint tape. As such, the contemplated device loaded, for example, with brad nails and drywall tape presents a heavy duty industrial application which is equally within the contemplated scope of the invention as that of a common staple/adhesive tape loaded Tapeler.

Finally, although the preferred embodiment depicts the Tapeler as having a raised boss 9, for imprinted material, it is contemplated that any of the numerous generally flat surfaces of the Tapeler are well suited for and may be utilized for the imprinting of graphical or advertising material for the purposes of advertising or promotion.

What is claimed is:

1. A Tapeler comprising:
a stapling device, having an integral tape dispenser;
said device having a pivoting connection between a stapling leg and a staple forming leg with each leg having an ergonomic contoured and cushioned outwardly facing surface;
said stapling device having graphical or advertising material imprinted on at least one external surface for the purpose of advertising or promotion.

2. The Tapeler of claim 1, wherein the graphical or advertising imprinted material is located at the pivoting connection between the legs of the stapling device.

3. The Tapeler of claim 1, wherein the graphical or advertising material is located on at least one of the legs of the stapling device.

4. The Tapeler of claim 1, wherein the graphical or advertising material is located on a raised surface boss on the stapling device.

5. The Tapeler of claim 1 wherein the stapling device utilizes staples.

6. The Tapeler of claim 1, wherein the stapling device utilizes nails.

7. The Tapeler of claim 1, wherein the stapling device further includes a belt clip for industrial use.

8. A Tapeler comprising:
a stapling device, having an integral tape dispenser;
said device having a pivoting connection between a stapling leg and a staple storage and forming leg with each leg having an ergonomic contoured and cushioned outwardly facing surface;
said stapling device having a readily engagable clip for attachment to another article; and having graphical or advertising material imprinted on at least one external surface for the purpose of advertising or promotion.

9. The Tapeler of claim 8, wherein the graphical or advertising material is located at the pivoting connection between the legs of the stapling device.

10. The Tapeler of claim 8, wherein the graphical or advertising material is located on at least one of the legs of the stapling device.

11. The Tapeler of claim 8, wherein the graphical or advertising material is located on a raised surface boss of the stapling device.

12. The Tapeler of claim 8, wherein the stapling device utilizes staples.

13. The Tapeler of claim 8, wherein the stapling device utilizes nails.

14. A method of advertising or promotion wherein graphical or advertising material is imprinted on at least one external surface of a Tapeler having a stapling device and an integral tape dispenser; said device having a pivoting connection between a stapling leg and a staple storage and forming leg, with each leg having an ergonomic contoured and cushioned outwardly facing surface.
